(19) United States
(12) Patent Application Publication
(10) Pub. No.: US 2022/0171898 A1
(43) Pub. Date: Jun. 2, 2022

(54) DIGITAL TWIN SIMULATION OF AN ARTICLE

(71) Applicant: International Business Machines Corporation, Armonk, NY (US)

(72) Inventors: Sarbajit K. Rakshit, Kolkata (IN); Amitava Maity, Kolkata (IN)

(21) Appl. No.: 17/108,508

(22) Filed: Dec. 1, 2020

(51) Int. Cl. G06F 30/20; G06Q 10/06; G06Q 10/08; G06Q 30/02; G06Q 30/06; G06Q 10/10; G06Q 10/00

(52) U.S. Cl. CPC G06F 30/20; G06Q 10/06395; G06Q 10/067; G06Q 10/087; G06F 2111/02; G06Q 30/0631; G06Q 10/10; G06Q 10/20; G06Q 30/0206

(57) ABSTRACT

In some embodiments, a processor may receive user specific information about anticipated operating conditions for a product. The processor may receive historical information associated with historical operating conditions for the product and historical product performance associated with the historical operating conditions. The processor may simulate anticipated product performance based on the historical information and the anticipated operating conditions utilizing a digital twin simulation for the product. The processor may generate a predicted cost of ownership of the product based on the simulated anticipated product performance. The cost of ownership may incorporate costs of ownership of one or more components of the product.

### BACKGROUND

The present disclosure relates generally to the field of digital twin simulation, and more specifically to simulating the requirements to maintain a product using digital twin simulation.

Digital twin simulations provide a replica of a product, process, or service. The quality of the digital twin simulation may depend on the quality of data used to create the simulation. In predicting a cost of ownership of a product or making a product recommendation, the quality of the prediction of cost or product recommendation may also vary.

### SUMMARY

Embodiments of the present disclosure include a method, computer program product, and system for simulating the requirements to maintain a product using digital twin simulation.

A processor may receive user specific information about anticipated operating conditions for a product. The processor may receive historical information associated with historical operating conditions for the product and historical product performance associated with the historical operating conditions. The processor may simulate anticipated product performance based on the historical information and the anticipated operating conditions utilizing a digital twin simulation for the product. The processor may generate a predicted cost of ownership of the product based on the simulated anticipated product performance. The cost of ownership may incorporate costs of ownership of one or more components of the product.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for digital twin simulation, in accordance with aspects of the present disclosure.

FIG. 2 is a flowchart of an exemplary method for digital twin simulation, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to digital twin simulation, and more specifically to simulating the requirements to maintain a product using digital twin simulation. While the present disclosure is not necessarily limited to such applications, various aspects of the disclosure may be appreciated through a discussion of various examples using this context.

In some embodiments, a processor may receive user specific information about anticipated operating conditions for a product. In some embodiments, the user specific information about anticipated (e.g., predicted, projected, etc.) operating conditions may include: information about usage conditions (e.g., a farming machine is anticipated to be used every three months to till 1000 acres of soil. The machine will be in use for 14 hours a day, with no breaks in those 14 hours, as the farming machine will be used by farmers working in shifts.); environmental parameters (e.g., the soil that is to be tilled by the machine is dry, in an area with 0.1 inches of rain per month, and rocky, with 10% of the topsoil being rocks larger than 3 inches in diameter. The average temperature during the first farming season of the year is 28° F., and the average temperature during the fourth farming season of the year is 110° F.); maintenance plans (e.g., the engine oil for the farming machine will be replaced every year. The tilling blades will be cleaned, inspected for damage, and replaced, if damaged, every 20 acres tilled, and the entire tilling assembly which will be replaced every 3 years.); skill of the operator (e.g., number of years' experience operating that type of product); user classification type (e.g., whether a refrigerator is being used for home use or for use in a hospital pharmacy); monitored usage behavior of an operator (e.g., a user), etc. In some embodiments, the product is any physical or electronic product that a user is trying to obtain information about to make a purchasing or maintenance/repair decision about the product.

In some embodiments, the monitored usage behavior of the operator may be assessed by monitoring the operator operating a product (e.g., with one or more sensors). In some embodiments, the product may be similar or related to the product to be purchased (e.g., a tractor with similar or identical specifications, another farming machine, or a car, when the product to be purchased is a tractor). For example, the operator's behavior may be monitored using Internet-of- Things (IoT) enabled devices that are connected to the product. Sensors may determine how the product is being used (e.g., payload or acceleration of the vehicle), and how the product is being used in different contextual situations (e.g., time of day, different day, in connection with certain environmental conditions like snow forecasted for the particular time of day or the different day).

In some embodiments, the monitored usage behavior may be aggregated to assess: the mistakes made by the operator while operating the product (e.g., the operator broke a tractor five times during the year when driving at speeds above 30 mph); or the effectiveness of the use of the product (e.g., the operator drove a planting machine at a maximum speed for the planting machine and 10% of the plants from his machine missed the planting holes in the soil).

In some embodiments, the monitored usage behavior of the operator may be used to create/generate a digital twin of the product to understand predicted repercussions of the monitored usage behavior on the product, including, but not limited to, degraded performance of the product, the lifespan of the product, and damage or breakdown of components of the product. In some embodiments, the monitored usage behavior of the operator may include aggregated monitored behaviors of multiple operators (e.g., the user may have a factory where a certain type of machine is operated by multiple operators). In some embodiments, the monitored usage behavior of the operator may be monitored (or evaluated) at various life stages of the product (e.g., when a car is new, when the car has 150,000 plus miles, after the car's transmission has been recently replaced, etc.).

The user specific information about anticipated operating conditions may be obtained by using an IoT system that receives real-time (or near real-time) environmental information (e.g., the conditions with/in which the product is operating) or performance information (e.g., engine temperature after 4 hours of operation) for related products already in use by the user (e.g., the user may already be using four farming machines of the same or different specifications, or the user may be using other farming machinery from which information about anticipated operating conditions may be obtained.).

In some embodiments, the processor may receive historical information associated with historical operating conditions for the product. In some embodiments, historical information about the operating conditions may include information aggregated from multiple user. The historical information may include information about each, any, or all factors regarding which user specific information was obtained (e.g., the factors or conditions in the anticipated operating conditions). Historical operating conditions may include usage conditions, environmental parameters, maintenance plans, skill of the operator, the operator's past usage behavior, compatibility with other devices (e.g., machine A is used with machine B, and machine B needs a particular type of connection with machine A), predicted changes in need (e.g., based on historical data, machine B is upgraded on average to a newer model every three years, and the connector for machine B will need to be compatible with machine A), etc.

In some embodiments, the processor may receive historical information associated with historical product performance associated with the historical operating conditions. In some embodiments, information about historical product performance may include information about: the performance output of the product (e.g., the overall product yield (e.g., a printing machine is capable of printing 1000 pages per minute)); the efficiency with which the product operates (e.g., 80% of maximum product yield); the performance of components of the product (e.g., a first component rotates at 25 rpms, and a second components is heated to 100° F. when turned on and stays within a ten degree temperature range during operation) measured by sensors or determined from interdependent or nearby components; and any conditions under which this performance output exist (e.g., for a particular time duration, for a particular yield, under only certain operational conditions, after repair or replacement of another component, etc.).

For example, historical operation conditions may include that the gears of a rotating component of a planting machine rotate at 35 rpms on average. Historical product performance may include that the total yield of the planting machine is an average of 1000 plants per hour per acre when operating with an average efficiency of 80% of the maximum during a first time period after the engine's oil has been replaced and 800 plants per hour per acre when operating with an average efficiency of 60% during a second period after the engine's oil has been replaced. The planting machine may operate at 83% efficiency when an entire rotating component is replaced with a replacement rotating component.

In some embodiments, information associated with historical product performance may also include information about maintenance, repairs, and service needed to achieve the historical product performance on a component-by-component basis. In some embodiments, the historical operating conditions are linked to the historical product performance for each, any, or all components.

In some embodiments, a processor may simulate anticipated product performance based on the historical information and the anticipated operating conditions utilizing a digital twin simulation for the product. In some embodiments, the anticipated product performance may include information about the same factors as the historical product performance. In some embodiments, the anticipated product performance may differ from the historical product performance in that the anticipated product performance may also factor in the anticipated operating conditions. For example, the processor may compare the anticipated operating conditions to the historical operating conditions aggregated from multiple users. The processor may determine for which factors (e.g., specific operating conditions of the set of operating conditions) the anticipated operating conditions differ from the historical operating conditions and by how much.

In some embodiments, the digital twin simulation may be a digital replica of the product. In some embodiments, the digital twin simulation may provide both the elements and the dynamics of how the product operates and lives throughout its life cycle, including how components of the product operate and live throughout their life cycle. This living model creates a thread between the physical and digital world. In some embodiments, IoT connected objects are replicated digitally, enabling simulations, testing, modeling and monitoring based on the data collected by the IoT sensors. In some embodiments, the digital twin simulation may assess anticipated product performance at the level of any or all components of the product. This may be done by uniquely identifying each and every part of the product in a bill of materials, obtaining data regarding the performance of each and every part (e.g., when the product was designed real- time data was obtained from each and every component of the product), and simulating the product performance of the machine, including any, each, or every component of the product.

In some embodiments, the digital twin simulation may determine which components of the product fail, the cause of the failure, and the repercussions of the failure. The causes of failure and the repercussions of failure may be used to determine which parts require maintenance or replacement, and/or may be used to determine/generate a schedule for maintenance, repair, and replacement of components. For example, the digital twin simulation may show that component A degrades to 40% performance after 3 weeks of utilization and 20% performance after 6 weeks of utilization. The digital twin simulation may show that component X fails because its operation is interconnected with the operation of component Y, and once the performance of component Y degrades below a threshold, component X breaks or fails to perform its job. When component A degrades to 40% performance, the overall performance of the product (e.g., a farming machine used to till soil) drops to 60% performance (e.g., only 60% of land is tilled in a set time period), and when component A degrades to 20% performance, this causes components B, C, and D to degrade to the point that they will fail/break in 3 weeks (as identified from historical information/product performance).

In some embodiments, a service life of the product may also be determined by simulating anticipated product performance utilizing the digital twin. The service life of the product (e.g., how long the product can be used given its performance degradation) may also incorporate the service life of each, all, or any components of the product. In some embodiments, the digital twin simulation may also anticipate appropriate levels of insurance or a warranty for the product (e.g., based on anticipated product performance).

In some embodiments, a processor may generate a predicted a cost of ownership of the product based on the simulated anticipated product performance. In some embodiments, the cost of ownership may incorporate costs of ownership of one or more components of the product. The cost of ownership may include costs that are fixed or independent of the state of repair/performance of the product. For example, fixed costs may include the purchase price of the product or related equipment (e.g., use of an IoT connected farming tool may also require that a tablet computer and mobile internet connection be purchased).

The cost of ownership may include costs that are dependent on the maintenance/repair of the product. For example, how much gasoline a tractor uses depends on the efficiency of the engine, which depends on how often the engine's oil is replaced. The cost of ownership may include costs for repairs, maintenance, upgrades, service, support, security, and training for operators of the product. Some of these costs may vary depending on different approaches that users may take to maintenance of the product. For example, a user may decide to purchase more oil for more frequent oil changes rather than incur the cost of replacing broken components which degrade more quickly with less frequent oil changes. Some of these costs may vary depending on the different approaches that users take to operation of the product. For example, a farmer may operate a farming machine with two shifts of workers to utilize the machine 14 hours a day rather than utilize the machine for 8 hours a day. When operating the machine for 14 hours a day, the machine operates at hot temperatures for more time, causing certain components to degrade more quickly and need additional maintenance or replacement.

In some embodiments, the cost of ownership may include costs of repairing or replacing damaged components of the product. In some embodiments, the cost of ownership may be the total cost of ownership. In some embodiments, the total cost of ownership may be a financial estimate to help users determine the direct and indirect costs of a product. In some embodiments, the total cost of ownership may include all of the previously described expenses and costs for the product.

In some embodiments, the processor may provide a product recommendation based on one or more recommendation factors. In some embodiments, the recommendation factors may be set automatically by the processor, selected by the user selecting (e.g., purchasing) the product, or a combination of the two approaches. In some embodiments, the recommendation factors may include parameters based on which the product for purchase is to be selected. In some embodiments, the recommendation factors may include: costs of ownership (e.g., a specific cost such as repair costs or training costs), a total cost of ownership, a service life of the product or any of its components, level of maintenance required to operate the product at a specific performance level (or efficiency level or cost level), level of skill required to operate the product at a specific performance level (or efficiency level or cost level), etc.

In some embodiments, the recommendation factors may be weighed, giving more weight to one or more of the recommendation factors, to determine the product recommendation. In some embodiments, the system may allow a user to select any one of the operating conditions (e.g., user specified or historical) to which to add greater or lesser weight in determining a product recommendation. For example, a user may choose to place greater weight on operational conditions related to environmental parameters that the user believes are less likely to change. As another example, the user may place less weight on the skill level of an operator of the product because the user is in the process of developing a training program for operators that will significantly increase their skills. In some embodiments, the product recommendation may be made in the form of recommended parameters for the product. For example, the product recommendation may specify the device specifications (e.g., a lawnmower with a steel frame, rather than an alloy frame) that are best to accommodate an operator's usage behavior (e.g., the operator historically has hit many tree trunks while mowing the lawn) and extend the service life of the product or reduce its cost of ownership.

In some embodiments, the processor may provide an operating plan for the product. In some embodiments, the processor may generate the operating plan for the product based on the digital twin simulation. In some embodiments, the operating plan may include usage parameters for use of the product.

To maintain a cost of ownership, a service life, any other factors, conditions in the operating conditions, or anticipated product performance of the product and its components, an operating plan may be provided to the user that details the usage parameters for operating the product for its intended purpose. In some embodiments, the operation plan may be a plan of action that details the conditions under which the product is to be used and which the user of the product may be able to control. In some embodiments, the conditions which the operating plan details may be factors or conditions of the historical operating conditions or the anticipated operating conditions input to simulate anticipated product performance. For example, the user may have provided user specific information about anticipated operating conditions, including that a farming machine may be used on 1000 acres per day. In order to maintain the total cost of ownership or the service life of the product, when the machine is used, it is to be used on 1000 acres per day.

In some embodiments, the usage parameters for operating the product may include the type of training required for the use of the product, the type (e.g., nature, frequency, etc.) of preventative maintenance required for the product, environmental parameters to be changed (e.g., changing the temperature controls in a factory or inserting air filters in the factory where the product is to be used), how the product is to be used (e.g., the machine is to be operational for only a maximum of 14 hours a day), the nature or frequency of maintenance and repair of the product on a component by component level, etc.

In some embodiments, usage parameters may include a time frame for the repair and maintenance for the product (and its components). For example, the usage plan for a machine may indicate that the engine oil needs to be replaced every 4 months, the gear system needs to be oiled every month, and the central axel needs to be checked for cracks every 5 months.

In some embodiments, the processor may monitor operating conditions of the product in an environment of a user. In some embodiments, the processor may determine a difference between the monitored operating conditions and the simulated operating conditions. In some embodiments, the processor may revise the operating plan for the product based, at least in part, on monitored operating conditions. In some embodiments, the operating conditions of the product in the environment of the user may be monitored using sensors in an IoT connected system where real-time (or near real-time) operation and performance of the product (e.g., the product purchased by the user) is monitored.

In some embodiments, the simulated operating conditions may be the operating conditions based on which the digital twin simulation that simulates anticipated product performance is created. In some embodiments, the simulated operating conditions aggregate the historical operating conditions and the anticipated operating conditions. For example, for a particular product, historical information may be available about 100 factors or conditions. The aggregated (e.g., the mean, medium, etc.) information about those 100 factors make up the historical operating conditions. The user may be able to provide user specific information for five of those factors. The anticipated operating conditions (five factors) provided by the user may be combined with the historical operating conditions for the remaining factors (95 factors) to arrive at the simulated operating conditions based on which the digital twin simulation is provided.

In another example, a user may specify that a machine being purchased will be operational for 10 hours a day, rather than for the historical average of 12 hours a day. After the machine is purchased, and the operating conditions of the product in the user's factory are observed, it may be determined that in actuality the machine is operated for an average of 11 hours per day. The operating plan may be revised based on the monitored operating conditions. For example, the revised operating plan may recommend that the machine's oil be replaced every 2.5 months, rather than the previously recommended 3 months, because of the longer operation hours monitored.

In some embodiments, the processor may monitor operating conditions of the product in an environment of a user. In some embodiments, the processor may determine a difference between the monitored operating conditions and the simulated operating conditions. In some embodiments, the processor may calculate a revised cost of ownership of the product based on a difference between the monitored operating conditions and the simulated operating conditions. In some embodiments, the revised cost of ownership may incorporate a revised cost of ownership of one or more components of the product.

Continuing the previous example, when it is monitored that a machine is used for 11 hours per day and the revised operating plan requires that engine oil be replaced every 2.5 months (rather than every 3 months), the revised cost of ownership may reflect the increased cost of oil. The revised cost of ownership may also reflect the maintenance, repair, replacement, or service costs for components of the machine that may degrade and/or fail at greater frequency when the machine is operational for an additional hour per day. In some embodiments, the difference between the predicted cost of ownership and the revised cost of ownership may be provided on a component by component basis. Additionally, a revised service life may be determined for each, any, or all of the components of the product.

In some embodiments, after determining a revised cost of ownership, the processor may provide a revised product recommendation based on the revised cost of ownership. For example, the user is the owner of a limousine company and purchases vehicles for use in the fleet at different times. After the operating conditions of a purchased vehicle are monitored and a revised cost of ownership is determined, a different vehicle may be recommended for the fleet based on the revised cost of ownership.

In some embodiments, the processor may receive data regarding a current condition of the product. In some embodiments, the data regarding the current condition of the product may reflect the maintenance and repair state of the product, the degradation of the product, and the performance (e.g., performance output or performance efficiency) of the product, for the product as a whole and for each, any, or all of the components of the product at a particular time. In some embodiments, the data regarding the current condition may be obtained from sensors in, on, or in proximity to the product, from other sensors configured to monitor the product (e.g., video cameras placed apart from the product), or from sensors in, on, or configured to monitor another machine/product which is connected with the product.

In some embodiments, data regarding the current condition of the product may be obtained from an IoT connected product. In some embodiments, the product may be newly obtained (e.g., purchased), and the current condition of the product may be obtained from data provided by the supplier of the product. For example, data regarding the current condition of the product may indicate that a pickup truck has been used by its owner for two years. The data regarding the current condition of the product may indicate that the vehicle's engine is operating at 65% efficiency compared to the productivity measured at the time the vehicle was newly purchased. The data regarding the current condition of the product may indicate that the vehicle's engine may provide a maximum of 105 horsepower and that the average fuel efficiency of the vehicle is 23 miles per gallon.

In some embodiments, the processor may receive data regarding monitored operating conditions and monitored product performance of the product. In some embodiments, the data regarding monitored operating conditions may include data regarding the maintenance and repair of the product, including how an operating plan was put in to effect, whether recommended usage parameters were complied with, and in what ways and to what extent the usage parameters were not complied with. For example, the data regarding monitored operating conditions of the pickup truck for the past two years may indicate that the truck was driven an average of 150 miles per day, the transmission fluid for the truck was replaced twice (once yearly), the engine oil was replaced twice (once yearly), the average inflation level of the vehicle's tires over two years was 29 psi (rather than 40 psi recommended), and the vehicle accelerated or decelerated at a rate greater than 8 m/s² (0.005 miles/s²) on average ten times per hour during its operation.

In some embodiments, data regarding monitored product performance may include data regarding the performance output, performance efficiency, or other information about how the product is functioning, for the entire product or for each, any, or all components of the product over time. Furthering the example above, the data regarding monitored product performance for the pickup truck may show that the average fuel efficiency of the truck decreased from 28 miles per gallon for the first six months of operation to 24 miles per gallon for the second six months, and from 22 miles per gallon for the third six months of operation to 18 miles per gallon for the fourth six-month time period. Continuing the example, the data regarding monitored product performance for the pickup truck may show that Component A of the engine operated at 75% efficiency during its first year of operation and 62% efficiency during its second year of operation, while component B of the engine operated at 98% efficiency for the first month of the pickup truck's operation and then degraded to 78% efficiency for the remaining 23 months (e.g., the proposed method described herein may be able to determine likely correlations between one point of data and another).

In some embodiments, the processor may receive data regarding operating conditions to be simulated for the product. In some embodiments, the processor may generate a simulation of the product based on the operating conditions to be simulated, where the simulation details one or more conditions of the product performance over a past or future time period. For example, a user may want to simulate how the pickup truck may perform during the next two years of its operation if the truck is driven on average 100 miles per day and the engine oil is replaced every six-months.

In some embodiments, the simulation generated may detail one or more conditions of the product performance, including conditions regarding the performance output, performance efficiency, damage state of a component, etc. In some embodiments, from the simulation of product performance, information about the cost of ownership (including maintenance costs), or the service life of the product, or its components, may be determined. For example, the simulation of the product may show that the fuel efficiency of the pickup truck stays at 16 miles per gallon for the remaining two years of projected operation. Accordingly, the cost of ownership may increase to include a cost of additional oil changes, which likely ensures that the lifespan of the engine will last the remaining two years. As another example, the user may want to simulate how the pickup truck would have performed in the previous two years of its operation if the truck was driven with an average tire pressure of 40 psi. The backward looking simulation may show that the average fuel efficiency of the product decreased from 34 miles per gallon for the first six months of operation to 32 miles per gallon for the second six months, and from 31 miles per gallon for the third six months of operation to 30 miles per gallon for the fourth six-month time period.

In some embodiments, the simulation may be in the form of a virtual reality simulation. In some embodiments, the virtual reality simulation may show the changing performance of the product as time progresses. In some embodiments, the rate at which the change in performance over time is simulated, the rate of the change, may be adjustable. For example, a user may see a virtual reality simulation of a truck as it drives 2,000 miles per week and the user may see a changing performance of the truck (e.g., the degradation of the components of its engine and the change in its fuel efficiency) over a five-year period. The speed at which the simulation shows the passage of time and the degradation of the product may be increased or decreased (five-year performance seen in one hour vs. five-year performance seen in three minutes).

In some embodiments, the simulation may permit the user to simulate the product's performance during the past as well as the future in one simulation. In some embodiments, based on the generated simulation of product performance over a past or future time period, a plan of action may be generated that details usage parameters for the use of the product. For example, the plan of action may include to check the vehicle's tire pressure once a week to maintain 40 psi and to change the engine oil twice a year, rather than once a year. In some embodiments, the processor may calendar the maintenance or service steps of the plan of action for the user.

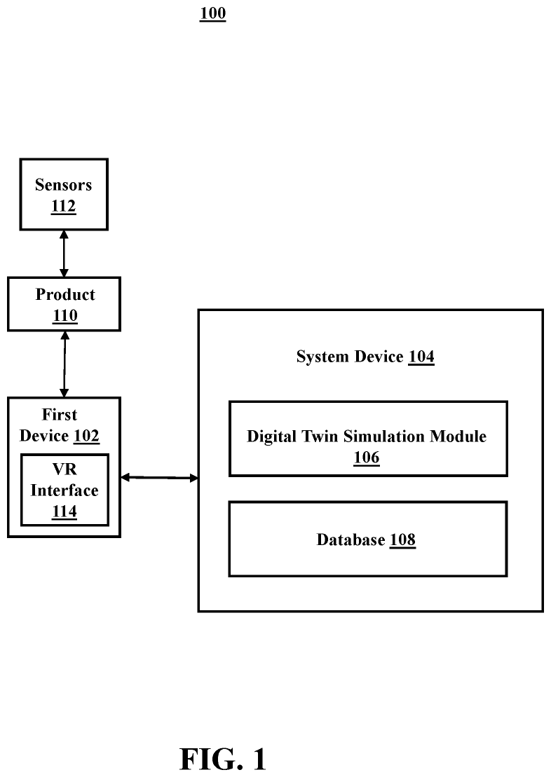

Referring now to FIG. 1, a block diagram of a network 100 for utilizing a digital twin simulation is illustrated. Network 100 includes a first device 102 (e.g., IoT client, computer, smartphone, etc.) and a system device 104 (e.g., IoT server, another computer, etc.). The first device 102 and the system device 104 are configured to be in communication with each other. In some embodiments, the first device 102 and the system device 104 may be any devices that contain a processor configured to perform one or more of the functions or steps described in this disclosure. System device 104 includes a digital twin simulation module 106 and a database 108 for storing data associated with historical information, monitored operating conditions and monitored product performance, user specific information gathered using real-time/historical data (e.g., regarding the operator's usage behavior), data regarding a current condition of a product, etc. (which are all discussed above).

In some embodiments, a processor of the system device 104 receives user specific information about anticipated operating conditions for a product 110 from the first device 102. The processor of the system device 104 also receives historical information associated with historical operating conditions for the product 110 and historical product performance associated with the historical operating conditions. In some embodiments, the historical information is stored in database 108. In some embodiments, anticipated product performance is simulated utilizing the digital twin simulation module 106, which is configured to provide a digital twin simulation for the product 110. The anticipated product performance is simulated based on the historical information and the anticipated operating conditions. The system device 104 generates a predicted cost of ownership of the product based on the simulated anticipated product performance. The cost of ownership incorporates costs of ownership of one or more components of the product 110.

In some embodiments, the system device 104 provides a product recommendation based on one or more recommendation factors. In some embodiments, the system device 104 generates an operating plan for the product 110 based on the digital twin simulation. In some embodiments, the operating plan includes recommended usage parameters for use of the product 110. In some embodiments, the system device 104 provides an operating plan for the product 110. In some embodiments, the usage parameters include a time frame for maintenance for the product 110.

In some embodiments, one or more processors of the system device 104, first device 102, or the product 110 monitor operating conditions of the product 110 in the environment of the user. In some embodiments, sensors 112 monitor the operating conditions of the product 110. In some embodiments, the one or more processors determine a difference between the monitored operating conditions and the simulated operating conditions. In some embodiments, the system device 104 revises the operating plan for the product 110 based, at least in part, on monitored operating conditions. In some embodiments, the system device 104 calculates a revised cost of ownership of the product 110 based on a difference between the monitored operating conditions and the simulated operating conditions. In some embodiments, the revised cost of ownership incorporates a revised cost of ownership of one or more components of the product 110. In some embodiments, the system device 104 provides a product recommendation based on the revised cost of ownership.

In some embodiments, one or more processors of the system device 104, the first device 102, or the product 110 receive data regarding a current condition of the product 110. In some embodiments, the data regarding the current condition may be obtained from the sensors 112 or from the database 108. In some embodiments, one or more processors of the system device 104, the first device 102, or the product 110 receive data regarding monitored operating conditions of the product, monitored product performance of the product, and operating conditions to be simulated for the product 110. In some embodiments, the system device 104 generates a simulation of the product 110 based on the operating conditions to be simulated. In some embodiments, the simulation details one or more conditions of the product performance over a past or future time period. In some embodiments, the simulation is provided to the user on a virtual reality interface 114 of the first device 102.

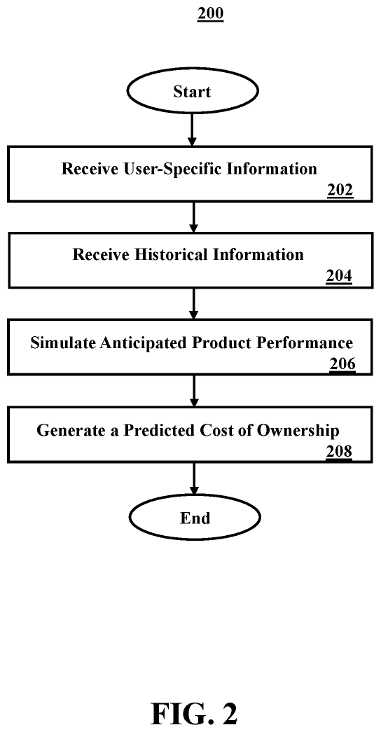

Referring now to FIG. 2, illustrated is a flowchart of an exemplary method 200 for utilizing a digital twin simulation, in accordance with embodiments of the present disclosure. In some embodiments, a processor of a system may perform the operations of the method 200. In some embodiments, method 200 begins at operation 202. At operation 202, the processor receives user specific information about anticipated operating conditions for the product. In some embodiments, method 200 proceeds to operation 204, where the processor receives historical information associated with historical operating conditions for a product and historical product performance associated with the historical operating condition. In some embodiments, method 200 proceeds to operation 206. At operation 206, the processor simulates anticipated product performance based on the historical information and the anticipated operating conditions utilizing a digital twin simulation for the product. In some embodiments, method 200 proceeds to operation 208. At operation 208, the processor generates a predicted cost of ownership of the product based on the simulated anticipated product performance. In some embodiments, the cost of ownership may incorporate costs of ownership of one or more components of the product.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load- balancing between clouds).

A cloud computing environment is service oriented with a focus on statelessness, low coupling, modularity, and semantic interoperability. At the heart of cloud computing is an infrastructure that includes a network of interconnected nodes.

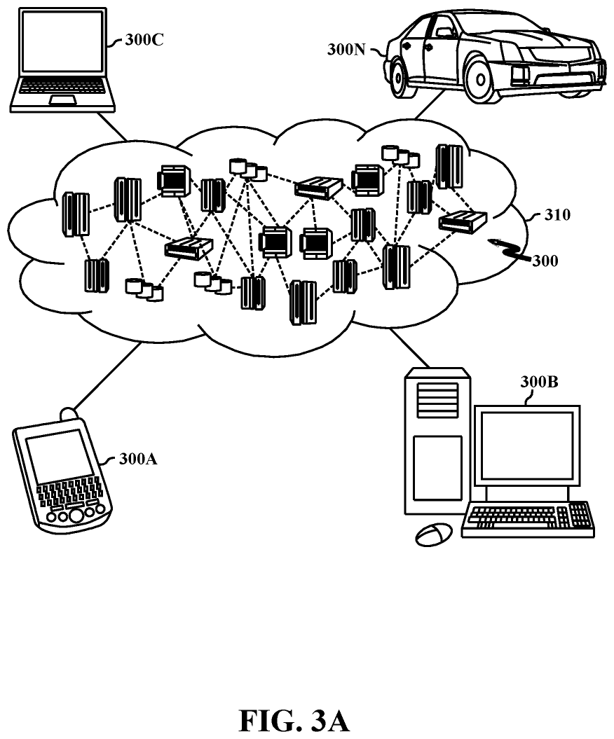

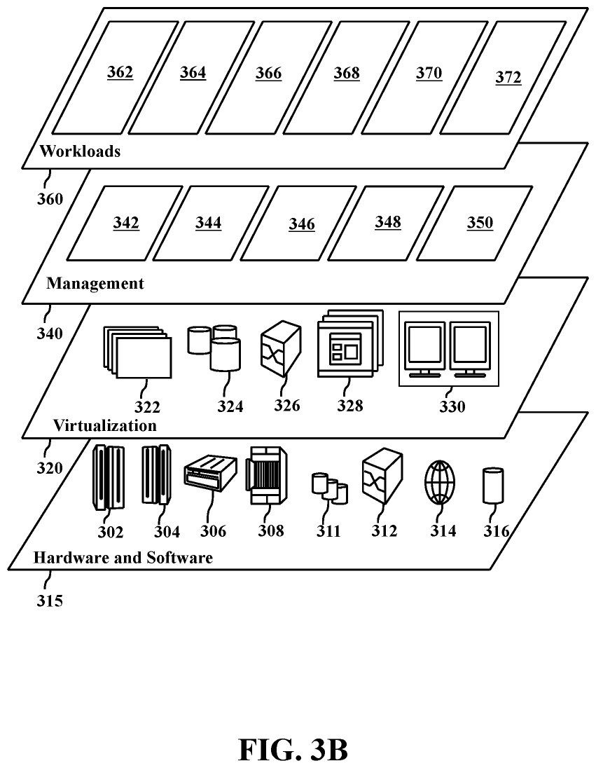

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and utilizing a digital twin simulation 372.

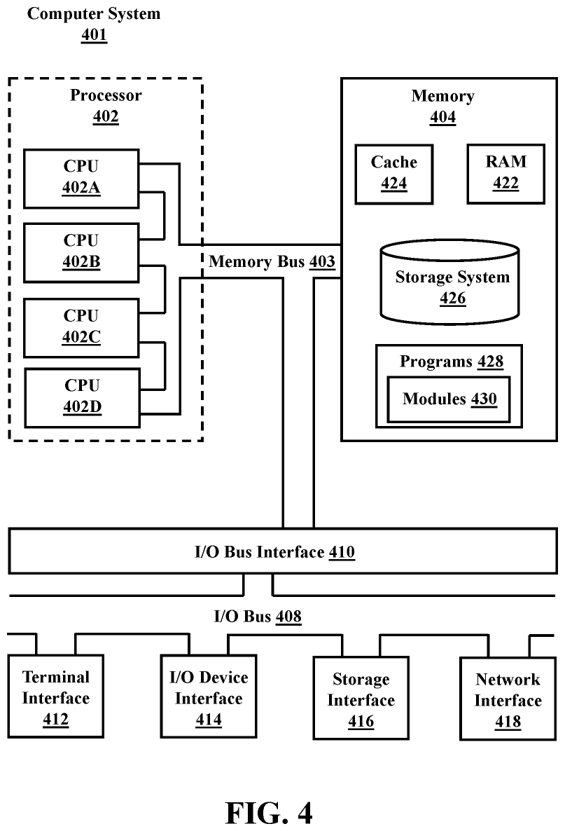

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand- alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, user specific information about anticipated operating conditions for a product;
receiving historical information associated with historical operating conditions for the product and historical product performance associated with the historical operating conditions;
simulating anticipated product performance based on the historical information and the anticipated operating conditions utilizing a digital twin simulation for the product; and
generating a predicted cost of ownership of the product based on the simulated anticipated product performance, wherein the cost of ownership incorporates costs of ownership of one or more components of the product.

2. The method of claim 1, further comprising:
providing a product recommendation based on one or more recommendation factors.

3. The method of claim 1, further comprising:
generating an operating plan for the product based on the digital twin simulation, wherein the operating plan includes recommended usage parameters for use of the product; and
providing an operating plan for the product.

4. The method of claim 3, wherein the usage parameters include a time frame for maintenance for the product.

5. The method of claim 3, further comprising:
monitoring operating conditions of the product in an environment of a user;
determining a difference between the monitored operating conditions and simulated operating conditions; and
revising the operating plan for the product based, at least in part, on the monitored operating conditions.

6. The method of claim 1, further comprising:
monitoring operating conditions of the product in an environment of a user;
determining a difference between the monitored operating conditions and simulated operating conditions; and
calculating a revised cost of ownership of the product based on a difference between the monitored operating conditions and the simulated operating conditions, wherein the revised cost of ownership incorporates a revised cost of ownership of one or more components of the product.

7. The method of claim 6, further comprising:
providing a product recommendation based on the revised cost of ownership.

8. The method of claim 1, further comprising:
receiving data regarding a current condition of the product;
receiving data regarding monitored operating conditions of the product, monitored product performance of the product, and operating conditions to be simulated for the product; and
generating a simulation of the product based on the operating conditions to be simulated, wherein the simulation details one or more conditions of the product performance over a past or future time period.

9. A system comprising:
a memory; and
a processor in communication with the memory, the processor being configured to perform operations comprising:
receiving user specific information about anticipated operating conditions for a product;
receiving historical information associated with historical operating conditions for the product and historical product performance associated with the historical operating conditions;
simulating anticipated product performance based on the historical information and the anticipated operating conditions utilizing a digital twin simulation for the product; and
generating a predicted cost of ownership of the product based on the simulated anticipated product performance, wherein the cost of ownership incorporates costs of ownership of one or more components of the product.

10. The system of claim 9, further comprising:
providing a product recommendation based on one or more recommendation factors.

11. The system of claim 9, further comprising:
generating an operating plan for the product based on the digital twin simulation, wherein the operating plan includes recommended usage parameters for use of the product; and
providing an operating plan for the product.

12. The system of claim 11, wherein the usage parameters include a time frame for maintenance for the product.

13. The system of claim 11, further comprising:
monitoring operating conditions of the product in an environment of a user;
determining a difference between the monitored operating conditions and simulated operating conditions; and
revising the operating plan for the product based, at least in part, on the monitored operating conditions.

14. The system of claim 9, further comprising:
monitoring operating conditions of the product in an environment of a user;
determining a difference between the monitored operating conditions and simulated operating conditions; and
calculating a revised cost of ownership of the product based on a difference between the monitored operating conditions and the simulated operating conditions, wherein the revised cost of ownership incorporates a revised cost of ownership of one or more components of the product.

15. The system of claim 14, further comprising:
providing a product recommendation based on the revised cost of ownership.

16. The system of claim 9, further comprising:
receiving data regarding a current condition of the product;
receiving data regarding monitored operating conditions of the product, monitored product performance of the product, and operating conditions to be simulated for the product; and
generating a simulation of the product based on the operating conditions to be simulated, wherein the simulation details one or more conditions of the product performance over a past or future time period.

17. A computer program product comprising a computer readable storage medium having program instructions embodied therewith, the program instructions executable by a processor to cause the processor to perform operations, the operations comprising:
receiving user specific information about anticipated operating conditions for a product;
receiving historical information associated with historical operating conditions for a product and historical product performance associated with the historical operating conditions;
simulating anticipated product performance based on the historical information and the anticipated operating conditions utilizing a digital twin simulation for the product; and
generating a predicted cost of ownership of the product based on the simulated anticipated product performance, wherein the cost of ownership incorporates costs of ownership of one or more components of the product.

18. The computer program product of claim 17, further comprising:
generating an operating plan for the product based on the digital twin simulation, wherein the operating plan includes recommended usage parameters for use of the product; and
providing an operating plan for the product.

19. The computer program product of claim 18, further comprising:
monitoring operating conditions of the product in an environment of a user;
determining a difference between the monitored operating conditions and simulated operating conditions; and
revising the operating plan for the product based, at least in part, on the monitored operating conditions.

20. The computer program product of claim 17, further comprising:
monitoring operating conditions of the product in an environment of a user;
determining a difference between the monitored operating conditions and simulated operating conditions; and
calculating a revised cost of ownership of the product based on a difference between the monitored operating conditions and the simulated operating conditions, wherein the revised cost of ownership incorporates a revised cost of ownership of one or more components of the product.
